(19) United States
(12) Patent Application Publication
(10) Pub. No.: US 2024/0351115 A1
(43) Pub. Date: Oct. 24, 2024

(54) VIBRATION DAMPING TOOLHOLDER FOR A METAL CUTTING TOOL

(71) Applicant: SECO TOOLS TOOLING SYSTEMS, Bouxwiller (FR)

(72) Inventors: Yannick GROLL, Bouxwiller (FR); Pascal KRUMHORN, Bouxwiller (FR); Alireza ALIAKBARI, Boxwiller (FR); George MORARU, Aix en Provence (FR)

(21) Appl. No.: 18/687,340

(22) PCT Filed: Aug. 30, 2022
(86) PCT No.: PCT/EP2022/074064

§ 371 Date: Feb. 28, 2024

(30) Foreign Application Priority Data
Aug. 31, 2021 (EP) 21315152.5

(51) Int. Cl. B23B 39/02; B23B 51/00

(52) U.S. Cl. CPC B23B 39/02; B23B 51/0007; B23B 2251/70

(57) ABSTRACT

A vibration damping toolholder for a metal cutting tool, the toolholder including a holder body provided with an internal cavity, which extends inside the holder body along the longitudinal axis, and which has a first cavity end at a first holder body end. The damping toolholder further includes a tuning mass, which is movably arranged inside the cavity and extends along the longitudinal axis, and which has a first tuning mass end at the first holder body end. The damping toolholder also includes a damping medium, which surrounds the tuning mass inside the cavity, and a single primary spring element, which is positioned inside the cavity. An outer spring element end is immovably fixed to a first cavity end at the longitudinal axis, and an inner spring element end is immovably fixed to the first tuning mass end at the longitudinal axis.

### TECHNICAL FIELD

The present invention relates to a vibration damping toolholder for a metal cutting tool.

### BACKGROUND

Various cutting tools are used for machining metal workpieces such as for example rotating or non-rotating cutting tools. Such tools typically comprise an elongate body with a cutting head at a front end, and, at a rear end, a shank for connecting the cutting tool to a machine tool. The cutting head comprises a cutting edge which may be integral with the cutting head or located on a replaceable cutting insert.

When cutting tools are operated, the cutting tool is subjected to cutting forces that may vary in intensity and/or direction. This may lead to undesired vibrations or oscillations in the cutting tool, which in turn may cause insufficient surface finish on the machined workpiece, or damage the cutting tool or the workpiece.

In U.S. Pat. No. 3,598,498 an adjustable device for damping vibrations in boring bars is shown. The device comprises a conical damping mass located in a conical axial bore. A hollow pin is threaded in an axially extending recess in the damping mass, and one end of an adjustable spring rod is inserted into the hollow pin. The other end of the adjustable spring rod is coupled to a wall of the bore via an adjustable sleeve. Damping fluid is provided in the bore.

A problem with this known device is that it is difficult to design the device to provide good and consistent damping over a desired frequency range and/or a desired amplitude range.

### SUMMARY

It is an object of the present invention to mitigate the shortcomings of the prior art and to provide a vibration damping toolholder that is easier to tune. This object is achieved according to the invention by means of a vibration damping toolholder for a metal cutting tool according to claim 1.

The present invention relates to a vibration damping toolholder for a metal cutting tool comprising a holder body. The holder body has a first holder body end, a second holder body end and a longitudinal axis extending from the first holder body end to the second holder body end. The holder body is provided with an internal cavity which is delimited by an internal cavity surface, extends inside the holder body along the longitudinal axis, and which has a first cavity end at the first holder body end. The damping toolholder further comprises a tuning mass, which is movably arranged inside the cavity. In a neutral rest position, the tuning mass extends along the longitudinal axis and has a first tuning mass end at the first holder body end. The damping toolholder further comprises a damping medium, which surrounds the tuning mass inside the cavity, and a single primary spring element, which is positioned inside the cavity, has an outer spring element end and an inner spring element end, and which has a longitudinal extension from the outer spring element end to the inner spring element end. The outer spring element end is immovable fixed to the first cavity end at the longitudinal axis, and the inner spring element end is immovable fixed to the first tuning mass end at the longitudinal axis.

Thus, the toolholder comprises a cavity in which a tuning mass, a primary spring element and a damping medium are arranged. These components constitute a mass damper system wherein the tuning mass corresponds to an oscillating mass, and the primary spring element and the damping fluid provide stiffness and damping. When designing the vibration damping toolholder, the desired stiffness and the desired damping that are needed for an optimized response to selected induced frequencies and/or amplitudes are calculated. Thanks to the configuration of and the immovable connections of the primary spring element, almost no damping is added to the system by the primary spring element. Furthermore, a damping medium, for example a fluid, may be chosen so that almost no stiffness is added to the system by the damping medium. Thus, the primary spring element and the damping fluid can be independently selected to meet the calculated values.

In contrast, in prior art devices including the device of U.S. Pat. No. 3,598,498, due to the mounting and configuration of the spring component, the spring component inherently also provides damping to the system. Thus, when adjusting the spring component of a prior art device to meet a desired stiffness, the damping of the device is affected as well. Therefore, it is considerably more difficult to design a prior art toolholder to give a desired response to a frequencies range and to amplitudes than it is with the vibration damping toolholder according to the present invention.

The primary spring element is immovable fixed to the first cavity end with the outer spring element end, and immovable fixed to the first tuning mass end with the inner spring element end. Thereby, there is no relative movement between the outer spring element end and the first cavity end, and between the inner spring element end the first tuning mass end. In other words, there is no relative translation or rotation between one respective end of the primary spring and the associated end it is connected to. The connection of the primary spring element at both its ends may be described as rigid. Thereby damping, caused by for example by friction, at the connection itself is negligible.

The tuning mass is movably arranged in the cavity so that during operation, vibrations of the toolholder causes the tuning mass to move, for example oscillate, inside the cavity. When the tuning mass is in a neutral rest position, the tuning mass extends along the longitudinal axis of the holder body. This may be the condition at equilibrium when the vibration damping toolholder is inactive or stationary.

According to an embodiment, the damping of the primary spring element is structural damping. This is to be understood such that any other form of damping that could originate from the primary spring element during normal operation of the vibration tool holder is so small that it is negligible compared to the structural damping. Other forms of damping than structural damping, which originate from the spring element, are magnitudes smaller and do not influence the vibration damping tool holder during normal operation thereof. Structural damping is to be understood as damping in the material of the primary spring element when the primary spring element operates, for example bends or flexes. Since structural damping of a spring element is low, this ensures that almost all damping added to the system originates from the damping medium. Thereby, the desired damping of the vibration tool holder can be achieved by selecting a suitable damping medium without considering damping of the primary spring element.

Optionally, the tuning mass is suspended by the primary spring element only. Since the damping medium yields to any force of the tuning mass, the primary spring element is then the only component that defines the position of the tuning mass when the tuning mass is in the rest position at equilibrium. Thereby, advantageously the vibration damping toolholder lacks components that could add to the damping or the stiffness of the damping medium or the primary spring element, respectively. Optionally, excluding the damping medium, the primary spring element is the only component in contact with the tuning mass in the rest position or in all positions thereof.

Preferably, the tuning mass is pivotably arranged in the cavity. According to an embodiment, the tuning mass is pivotable around an axis at the primary spring element. The tuning mass is for example pivotable over an angle α around several different axes perpendicular to the longitudinal axis. Preferably, the tuning mass is pivotable around each axis that is perpendicular to the longitudinal axis. For each pivot axis of the tuning mass, the primary spring element may function as or similar to a cantilever spring that is fixed in one end and carries a mass in form of the tuning mass in the other end. The inertia that a pivoting tuning mass provides to the system is dependent on the length of the tuning mass. When pivoting in the limited space of the cavity, a long tuning mass can provide more inertia to the system than a conventional mass of the same size that is suspended for a translating movement. Thereby, advantageously the tuning mass can weigh less than a conventional, translating mass and still achieve the same or better damping results. Therefore, the tuning mass of the vibration damping toolholder according to the embodiment advantageously may add less weight to the toolholder than a translating mass of a prior art tool with the same dimensions.

Preferably, the first cavity end comprises a first cavity end surface and the first tuning mass comprises a first tuning mass end surface. Preferably, both of the end surfaces are planar at the connection with the associated ends of the primary spring element, wherein both end surfaces contact, or are integral with, the periphery of the associated end of the primary spring element. Thereby, the primary spring element protrudes from both the respective planes. Such designs allow the tuning mass to pivot freely and with a maximal distance to a pivot axis at the primary spring element. Furthermore, it is ensured that the first cavity end and the first tuning mass end affect the stiffness of the primary spring element as little as possible. Optionally, both end surface extend in planes normal to the longitudinal axis.

The primary spring element may be of any suitable kind having an elongated extension between two opposite ends. Preferably, the primary spring element is arranged and configured to bend in response to excitation from the tuning mass. Thus, the primary spring element is bendable, wherein the tuning mass is pivotable by the primary spring element bending. Preferably, when the tuning mass is in a neutral rest position, the primary spring element extends along the longitudinal axis of the holder body. This may be the condition at equilibrium when the vibration damping toolholder is inactive or stationary. For example, the primary spring element is a separate component in form of a rod, a tube or a helical thread that is attached to the first cavity and the first tuning mass end. Preferably, the primary spring element is a solid rod.

According to an embodiment, the first cavity end, the first tuning mass end and the primary spring element are integral and made of a one piece workpiece. Thereby it is advantageously ensured that the two primary spring element ends are immovably connected to a respective one of the first cavity end and the first tuning mass end. For example, the primary spring element is a rod extending from the first cavity end to the first tuning mass end, wherein the rod is integral with both the first cavity end and the first tuning mass end.

A preferred method of producing the tuning mass, the first cavity end and the primary spring element is to provide a solid blank having the shape of the tuning mass. Then, material is removed from the solid blank close to one end thereof until a desired shape of the primary spring element is obtained. The primary spring element may have a smallest cross sectional area that is smaller than an average cross sectional area of the tuning mass. For example, by turning a solid cylindrical blank, a primary spring element may be formed between a remaining portion of material at the outer end, which portion forms the cavity end, and a remaining portion of material at the inner end, which portion form the tuning mass. Preferably, the cavity, the tuning mass, and the primary spring element have a circular cross section.

Optionally, the tuning mass comprises tungsten, tungsten carbide, tungsten alloy, cemented carbide, steel or steel alloy. Optionally, the primary spring element comprises tungsten, tungsten carbide, tungsten alloy, cemented carbide, steel or steel alloy. In an embodiment where the first cavity end, the first tuning mass end and the primary spring element are integral and made of a one piece workpiece, the one piece workpiece comprises a material from this list, preferably cemented carbide or steel. Preferably, the cavity is formed in a body comprising a material from this list.

The tuning mass may have any suitable shape. The shape of the tuning mass may be selected according to desired weight and/or inertia. Since a pivoting tuning mass has larger movements than a corresponding conventional translating mass, the tuning mass provides more inertia to the system than when translating. It is advantageous to provide a cavity that extends over the total available length of the toolholder body and to arrange a tuning mass that is as long as possible in the cavity so that inertia of the pivoting tuning mass is as large as possible. The tuning mass may thus extend all the way from the primary spring element at the first cavity end to an opposite end of the cavity. In order to further increase inertia, the mass of the tuning mass may be concentrated at the end which is distal to the first tuning mass end.

Preferably, the tuning mass has only circular cross sections. Thereby, the tuning mass has equal qualities in all directions perpendicular to the longitudinal axis, which are the pivoting directions. Optionally, the tuning mass is cylindrical, conical or spherical. Optionally, the tuning mass is solid or hollow.

The outer surface of the tuning mass may be selected with respect to desired interaction with the damping medium. Optionally, the outer surface of the tuning mass is smooth, rough or comprises protruding elements such as fins.

The primary spring element adds stiffness to the vibration damping tool holder. The smallest cross sectional area of the primary spring element determines the stiffness of the primary spring element. According to an embodiment, the primary spring element has a cross sectional area that increases in both directions from a smallest cross sectional area at a distance from both the outer spring element end and the inner spring element end towards each respective end. Such design enables exact choice of stiffness while at the same time the risk of crack formation is reduced. The primary spring element is for example a solid component with circular cross sections, wherein the smallest cross sectional area of the primary spring element, for example is in the middle between the ends. In other embodiments, the cross sectional area of the primary spring element is constant along a portion, for example a major portion, or along the entire longitudinal length of the primary spring element.

Preferably, the damping medium is a fluid, and more preferably a liquid. The damping medium may also be a combination of several materials and/or a combinations of a fluid, a gas or a solid. In case the damping medium is a fluid, the cavity is closed and preferably sealed to securely hold the fluid and prevent leakage.

The damping medium is located in the cavity and surrounds the tuning mass. The damping medium may be selected to achieve the desired damping taking into account the selected tuning mass, primary spring element and/or internal cavity. For example, after first selecting a suitable density and geometry for the tuning mass and a suitable geometry for the cavity, by selecting a suitable type of damping medium, and/or a suitable distribution of the damping medium in the cavity, the desired damping of the vibration damping tool holder is achieved.

For example, the damping medium is distributed along the tuning mass in the longitudinal direction and in the circumferential direction. Optionally, the damping medium fills part of or the entire cavity, is evenly or unevenly distributed. Therein, the tuning mass may be only partly surrounded by the damping medium. The damping medium may for example be concentrated at an end in the cavity which is opposite to the first cavity end. Thereby, the damping properties of the toolholder can be designed for specific damping properties.

Generally, when establishing stiffness and damping of a structure, the Frequency Response Function (FRF) of the structure is obtained, for example using an impact hammer test or shaker test. When the FRF has been calculated in the frequency domain, the corresponding curve can be plotted with frequency against magnitude. A target natural frequency, which is the natural frequency that is of concern for a desired application, can be seen as a peak of the curve. The location of the peak, i.e. the natural frequency, is an indication of the stiffness of the structure at this frequency. The width of the curve at the peak is an indication of the damping at this frequency.

Generally, stiffness and mass are two primary elements determining the natural frequency of a structure. When adding damping medium to the vibration damping tool holder, the mass of the damping medium is neglectable compared to the mass of the holder body and the tuning mass. However, when comparing the FRF curves obtained for a damping vibration tool holder without and with damping medium, the natural frequency of the peak differ. This change is indicative to added stiffness to the vibration damping tool holder by the damping medium.

According to an embodiment, damping medium in form of damping fluid is selected and distributed in the internal cavity such that a target natural frequency of the vibration damping tool holder is decreased thereby at most 15%, preferably at most 10%. A small portion of stiffness originating from the damping fluid contributes further to ensuring that almost all stiffness added to the system is provided by the primary spring element. In addition, thanks to the low damping of the primary spring element, almost all damping of the system is provided by the damping medium. Thus, the primary spring element and the damping fluid can be independently selected to meet the desired properties of the vibration damping tool holder.

The combination of the pivoting tuning mass, the primary spring element providing an exact selectable stiffness, and a separate damping medium providing an exact selectable damping, advantageously achieves a high independence from the amplitude of induced vibrations of the vibration damping toolholder. Therefore, embodiments of the vibration damping toolholder have an increased efficiency for low amplitudes as compared to prior art devices which comprises a translating mass suspended by components having both stiffness and damping properties.

Optionally, the vibration damping toolholder further comprises an auxiliary elastic element arranged in the cavity, wherein the auxiliary elastic element is arranged and configured to be excited by the tuning mass only when the tuning mass pivots above a threshold angle α. The elastic element adds mainly stiffness to the system, but also has inherent damping. The inherent damping may originate from the shape of the elastic element and/or from the chosen elastic material.

Preferably, the auxiliary elastic element comprises a polymer, such as for example nitril, silicon or polyethylene. Generally, an advantage with elastic polymer elements in damping systems is that they work well for high amplitudes. Thus arranging a polymer elastic element in an embodiment of the damping vibration toolholder which element is only active when induced vibrations have high amplitude, enables to increase the efficiency of the toolholder for high amplitudes without affecting already good results at low amplitudes.

Preferably, the tuning mass is maximally pivotable a maximal angle α, and wherein the threshold angle is at least 20% of the maximal angle. The maximal angle α may be determined by the maximal arc length the tuning mass can pivot without contacting the cavity wall. In embodiments with cylindrical tuning mass and cavity, the threshold angle may correspond to a radial movement of the distal end of the tuning mass of 20% of a difference in diameter between the tuning mass and the cavity. The distal end of the tuning mass is opposite to the first end and is the end that is closer to the second holder body end.

According to an embodiment, the vibration damping toolholder further comprises a secondary auxiliary elastic element arranged in the cavity for damping vibrations in the longitudinal direction. The secondary auxiliary elastic element may for example be arranged between the distal end of the tuning mass and a cavity wall at the second holder body end. The influence of secondary auxiliary elastic element is preferable neglectable for pivoting movements of the tuning mass below the threshold angle.

Optionally, the auxiliary elastic element is arranged to compress or stress in response to excitation from the tuning mass.

According to a preferred embodiment, the first holder body end is a front end with an interface for supporting a cutting head. Thereby, the spring element is located close the cutting head where vibrations are induced during operation. Furthermore, countering force from the pivoting tuning mass act on the spring element and thus close to the cutting head. Another advantage is that most of the damping takes place at a distal end of the tuning mass, i.e. at the end located furthest away from the primary spring element and the cutting head where heat is generated during operation. Since many damping mediums are sensitive to heat or alter their damping properties in response to heat, the damping properties of the embodiment of the vibrations damping toolholder are therefore less heat sensitive.

The vibration damping toolholder according to the present invention may be comprised in a metal cutting tool, such as for example a turning, milling, drilling or boring tool. Preferably, the metal cutting tool is a non-rotating metal cutting tool, such as for example a boring tool. Boring tools, when used to cut deep holes, are especially prone to vibrations due to the necessary large length of the toolholder. Thanks to the tuning mass of embodiments of the vibration damping toolholder relying mainly on inertia as described above, a long tuning mass with small diameter can be used. This is advantageous in long boring bars intended for deep holes with small diameter.

According to an embodiment, the non-rotating metal cutting tool, such as the boring bar, comprises an elongate body including the vibration damping toolholder, and a cutting head. According to a preferred embodiment, the holder body comprises an interface at the first holder body end, which is the front end, for releasably connecting the cutting head to the vibration damping toolholder. In other embodiments, the cutting head is integral with holder body. The cutting head comprises a cutting edge which may be integral with the cutting head or located on a replaceable cutting insert. A shank for connecting the cutting tool to a machine tool is provided at the second holder body end, which is a rear end. Optionally, the shank is provided with a coupling, such as for example a Coromant Capto© coupling.

### BRIEF DESCRIPTION OF THE DRAWINGS

In the following, example embodiments will be described in greater detail and with reference to the accompanying drawings, in which:

FIG. 1 is a perspective view of a first embodiment of a non-rotating metal cutting tool comprising the vibration damping toolholder in form of a boring bar;

FIG. 2 is a perspective view of the vibration damping toolholder as shown in FIG. 1 showing only the tuning mass and the front/first end of the cavity;

FIG. 3a, b are side views of the boring bar as shown in FIG. 1, which shows the vibration damping toolholder of FIG. 2 in a schematic longitudinal section;

FIGS. 4-9 are longitudinal sections of alternative embodiments of the vibration damping toolholder;

All the figures are schematic, not necessarily to scale, and generally only show parts which are necessary in order to elucidate the respective embodiments, whereas other parts may be omitted or merely suggested. Unless otherwise indicated, like reference numerals refer to like parts in different figures.

### DETAILED DESCRIPTION

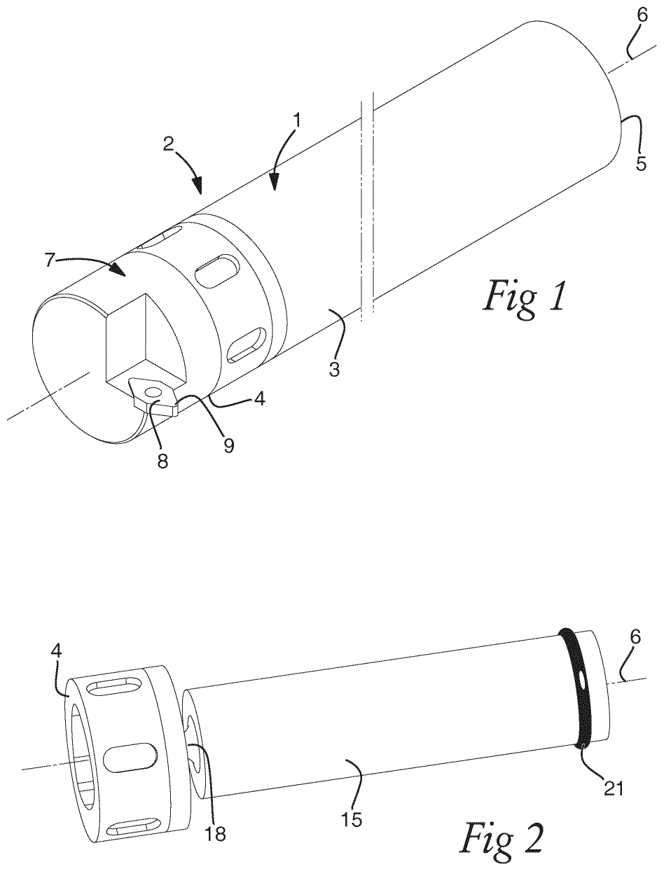

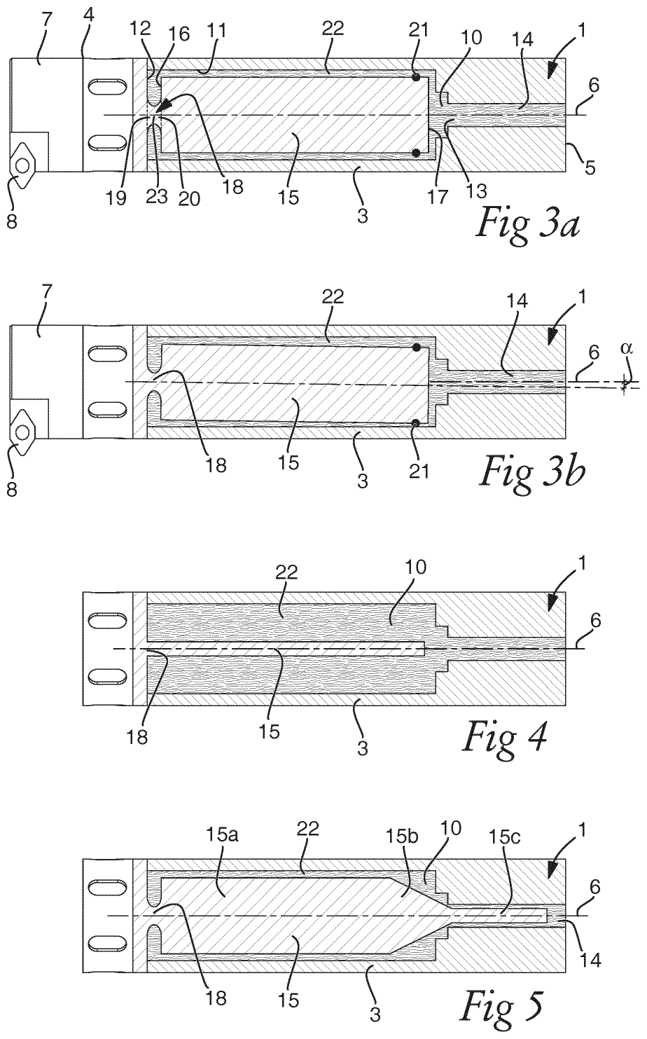

With reference to FIGS. 1-3, a first embodiment of the vibration damping toolholder 1 is shown. The toolholder 1 is a toolholder for a non-rotating metal cutting tool in form of a boring bar 2. The toolholder comprises a holder body 3, which has a first holder body end in form of a front end 4, and a second holder body end in from of a rear end 5. The holder body has a longitudinal extension along a longitudinal axis 6 from the front end 4 to the rear end 5. In the metal cutting boring tool 1 of FIG. 1, a cutting head in form of a boring head 7 is connected to the holder body 3 of the toolholder 1 at the front end 4. As can be seen in FIG. 2, the holder body 3 is provided with an interface in form of a coupling, specifically a Coromant Capto© coupling, for receiving a corresponding coupling (not shown) at the cutting head 7. A replicable cutting insert 8 with a cutting edge 9 is attached to the cutting head 7.

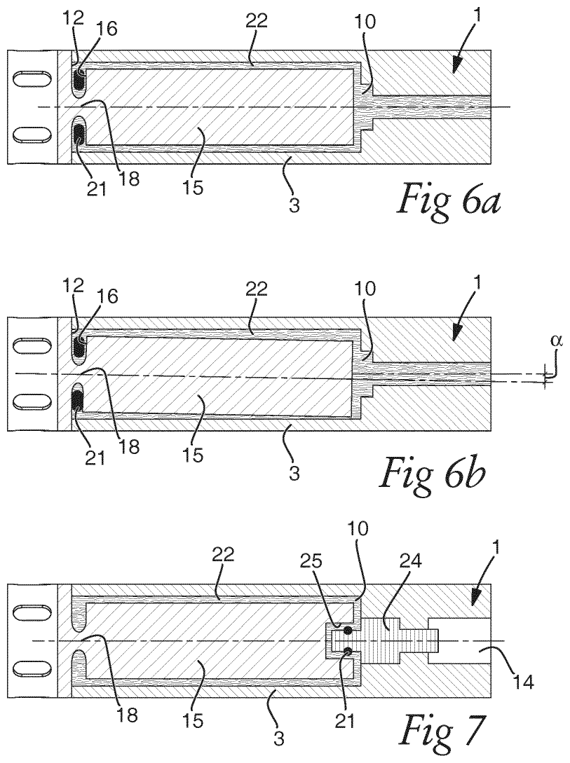

With reference to FIG. 3, the holder body 3 is provided with an internal cavity 10, which is delimited by a cavity surface 11. The cavity 10 extends inside the holder body 3 along the longitudinal axis 6 from a first cavity end in form of front end. The cavity 10 has a front end surface 12 at the front end and a rear end 13 at an opposite end, which is closer to the second holder body end 5. At the rear end 13, a duct 14 is in fluid communication with the cavity for connecting the cavity 10 with the outside of the holder body 3 at the rear end 5.

The toolholder 1 further comprises a tuning mass 15. The tuning mass 15 is movably arranged inside the cavity 10 and extends along the longitudinal axis 6 in a neutral rest position shown in FIG. 3. The tuning mass 15 has a first tuning mass end in form of a front end 16 at the front end surface 12 of the cavity 10. The tuning mass 15 has a rear end surface 17 at an opposite end, which is closer to the rear end 5 of the holder body 3.

A single primary spring element 18 is positioned inside the cavity 10. The primary spring element has longitudinal extension from an outer spring element end 19 to an inner spring element end 20.

The front end with the front end surface 12 of the cavity 10, the tuning mass 15 having the front end with the front end surface 16 and the primary spring element are integral and made of a one piece workpiece and comprise cemented carbide. In the example embodiment, the one piece component weighs 0.44 kg. Thereby the two primary spring element ends 19, 20 are immovably fixed to a respective one of the front end surface 12 of the cavity 10 and the front end surface 16 of first tuning mass 15.

The tuning mass 15, and the primary spring element, the cavity 10 and the duct 14 all are have a circular cross sections along their full lengths. The tuning mass 15 and the main chamber of the cavity 10, which houses the primary spring element and 18 and the tuning mass 15, are cylindrical. In the example embodiment, the tuning mass 15 is 90 mm long from a longitudinal centre of the primary spring element 18 to the distal end and has a diameter of 23 mm.

The primary spring element 18 has a cross sectional area that increases in both directions from a smallest cross sectional area 23 half way between the outer spring element end 19 and the inner spring element end 20 towards each respective end 19, 20.

The toolholder 1 further comprises an auxiliary elastic element 21 in form of a polymer O-ring. The O-ring 21 is arranged in a slot in the peripheral surface of the tuning mass 15 at the rear end.

A damping medium 22 in form of an oil having a viscosity of 20 mm²/s fills the remaining space in the cavity 10.

In FIG. 3a, the toolholder 1 is inactive and stationary. The primary spring element 18 is in a rest position at equilibrium and extends along the longitudinal axis 6 of the holder body 3 and the tuning mass 15. In the shown rest position, the O-ring 21 does not contact the cavity surface 11 so that the tuning mass 15 is suspended by the primary spring element 18 only.

During operation, fluctuating cutting forces from the cutting edge 9 of the cutting insert 8 act on the boring bar. Thereby the holder body 3 is caused to oscillate and vibrate by pivoting around axis at the primary spring element 18. Inertia from the tuning mass 15 causes the primary spring element 18 to bend, so that the tuning mass 15 pivots around axis that are perpendicular to longitudinal axis 6 at the primary spring element 18.

A damping medium in form of a damping liquid is selected and distributed in the internal cavity such that a target natural frequency of the vibration damping tool holder is decreased thereby at most 10%. This is verifiable through experiments in form of impact hammer tests, and by calculating a Frequency Response Function (FRF) in the frequency domain for the vibration damping tool holder with and without damping medium. Thus, essentially all stiffness added to the system originates from the primary spring element. Thus, the desired spring constant can be obtained by providing the primary spring element 18 with suitable cross sectional areas along the length thereof.

In the first example embodiment, the damping medium is a liquid. A damping liquid that works well with the pivoting tuning mass and the primary spring element of the first embodiment of the vibration damping tool holder is a liquid with low viscosity, for example an oil having a viscosity below 50 mm²/s, preferably below 20 mm²/s.

In the first example embodiment, the damping of the primary spring element 18 is structural damping and all other forms of damping originating from the primary spring element including the ends 19 and 20 thereof are negligible. Thus, essentially all damping added to the system originates from the damping medium 22.

With proper tuning of the stiffness of the primary spring element 18, the damping of the damping medium 22 and the weight/inertia of the tuning mass 15, the movement of the tuning mass will act against the movement of the holder body 3 and thus damp vibrations thereof. The tuning mass 15 moves with a different phase and/or frequency.

Thanks to the design with the primary spring element 18 and the pivoting mass, the vibration damping toolholder according to the first embodiment is more sensitive to low amplitudes than conventional prior art devices with a translating mass. Therefore, the vibration damping toolholder has similar damping properties for a larger range of amplitudes. In other words, the vibration damping toolholder is less amplitude dependent.

The tuning mass 15 pivots over a larger angle α in response to increasing amplitudes. When the angle α reaches a threshold value, the O-ring 21 contacts the cavity wall 11, c.f. FIG. 3b. The O-ring 21 is excited by the tuning mass 15 pushing it against the cavity wall 11 so that it is compressed. Thanks to the arrangement of the O-ring 21 in the first embodiment of the damping vibration toolholder so that it is only active when induced vibrations have high amplitude, the efficiency of the toolholder for high amplitudes are increased without affecting already good results at low amplitudes.

In the first example embodiment, the maximal angle α that the tuning mass 15 can pivot in the available space in the cavity 10 is 1.3°. The threshold angle α is 0.26°.

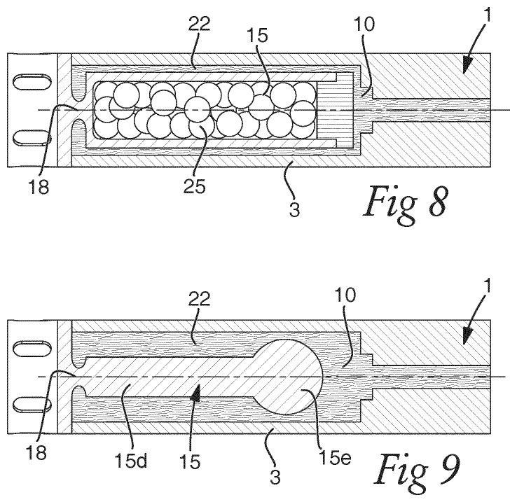

In FIGS. 4-9 alternative embodiments of the vibration damping toolholder 1 are shown. These embodiments differ from the first embodiment described above mainly by the design of the tuning mass 15, the primary spring element 18 and the auxiliary elastic element 21, why the description of the embodiments of FIGS. 4-11 is focused on these components.

In FIG. 4, an embodiment of a vibration damping toolholder 1 is shown, wherein the primary spring element 18 are in form of a long rod with a small, circular cross section. The primary spring element 18 and the tuning mass 15 in form of the rod have the same, constant cross section over their total lengths. Due to the pivoting, long tuning mass 15 of the embodiment, it provides sufficient inertia to the damping system even though it is not big and heavy. This embodiment is advantageous for applications where the toolholder is to be inserted into small diameter holes so that it cannot have a large cross section.

In FIG. 5, an embodiment of a vibration damping toolholder 1 is shown, wherein the tuning mass 15 comprises three sections. A first section 15a closest to the primary spring element is cylindrical with a cross section that is maximized to fit in the cavity while leaving a suitable gap for allowing pivoting. The section 15a is similar to the tuning mass 15 of the first embodiment. A third section 15c extends into the duct 14 and is formed as a cylindrical rod with a constant small cross section similar to the tuning mass 15 of the embodiment of FIG. 4. A second, middle section 15b, is located in between the first section 15a and the third section 15c forms a conical transition. Due to the extension of the tuning mass 15 into the duct, it can be made longer so that it provides more inertia to the damping system. The conical section 15b ensures that no new spring elements are introduced at the transition from the first section 15a with large cross section to the third section 15c with small cross section.

In FIG. 6a, b, an embodiment of a vibration damping toolholder 1 is shown, wherein the tuning mass 15 and the primary spring element 18 are similar of the embodiment of FIG. 4. The embodiment has a different type of auxiliary elastic element 21 in form of an O-ring that is arranged around the primary spring element 18. In FIG. 6a, the toolholder 1 is inactive and stationary.

The primary spring element 18 is in a rest position at equilibrium and extends along the longitudinal axis 6 of the holder body 3 and the tuning mass 15. In the shown rest position, the O-ring 21 is in contact with the front end surface 16 of the tuning mass 15, but does not contact the front end surface 12 of the cavity 10. In the rest position of FIG. 6a, the tuning mass 15 is suspended by the primary spring element 18 only.

In FIG. 6b, the tuning mass 15 has pivoted over an angle α that is larger than the threshold value. The O-ring 21 has been brought into contact with the front end surface 12 of the cavity 10 and is excited by being pushed against the front end surface 12 of the cavity 10 by the front end surface 16 of the tuning mass 15 so that it is compressed. Thereby the O-ring 21 of the embodiment of FIG. 6a, b, increases the efficiency of the toolholder for high amplitudes are increased without affecting already good results at low amplitudes.

The embodiment of a vibration damping toolholder 1 as shown in FIG. 7 is similar to the embodiment of FIG. 3. In the embodiment of FIG. 7, a shaft 24 is arranged in the duct 14. An auxiliary elastic element 21 in form of an O-ring is arranged around the shaft 24 and to interact with an internal recess wall surface 25 of the tuning mass 15 during amplitudes causing pivoting above the threshold angle α.

In FIG. 8, an embodiment of a vibration damping toolholder 1 is shown, wherein the tuning mass 15 comprises spherical balls 25. In this embodiment, it is possible to design the weight and the weight distribution of the tuning mass 15 by selecting suitable balls and their position inside the tuning mass 15. The balls 25 may have the same or different weight. The cavity may comprise several compartments for holding selected balls in order to ensure that the desired weight distribution is maintained.

In FIG. 9, an embodiment of a vibration damping toolholder 1 is shown, wherein the tuning mass 15 comprises two sections. A first section 15d closest to the primary spring element is cylindrical rod with a small cross section similar to the rod of the embodiment of FIG. 4. A second section 15d comprises a spherical ball having a diameter that is maximized to fit in the cavity while leaving a suitable gap for allowing pivoting. This design of the tuning mass 15 is advantageous for providing high inertia within a limited space of the cavity 10.

1. A vibration damping toolholder for a metal cutting tool, the toolholder comprising:
a holder body, wherein the holder body has a first holder body end, a second holder body end and a longitudinal axis extending from the first holder body end to the second holder body end, the holder body being provided with an internal cavity which is delimited by an internal cavity surface, which extends inside the holder body along the longitudinal axis, and which has a first cavity end at the first holder body end;
a tuning mass movably arranged inside the cavity, which, when in a neutral rest position, extends along the longitudinal axis, and which has a first tuning mass end at the first holder body end;
a damping medium, which surrounds the tuning mass inside the cavity; and
a single primary spring element positioned inside the cavity, and which has a longitudinal extension from an outer spring element end to an inner spring element end, wherein the outer spring element end is immovably fixed to the first cavity end at the longitudinal axis, and the inner spring element end is immovably fixed to the first tuning mass end at the longitudinal axis.

2. The vibration damping toolholder as claimed in claim 1, wherein the damping of the primary spring element is structural damping.

3. The vibration damping toolholder as claimed in claim 1, wherein the tuning mass is suspended by the primary spring element only.

4. The vibration damping toolholder as claimed in claim 1, wherein the primary spring element is bendable and the tuning mass is pivotable over an angle around axes at the primary spring element which are perpendicular to the longitudinal axis by the primary spring element bending.

5. The vibration damping toolholder as claimed in claim 1, wherein, the first cavity end, the first tuning mass end and the primary spring element are integral and made of a one piece workpiece.

6. The vibration damping toolholder as claimed in claim 1, wherein the cavity, the tuning mass, and the primary spring element each have a circular cross section.

7. The vibration damping toolholder as claimed in claim 1, wherein the primary spring element has a cross sectional area that increases in both directions from a smallest cross sectional area at a distance from both the outer spring element end and the inner spring element end towards each respective end.

8. The vibration damping toolholder as claimed in claim 1, wherein the damping medium is a fluid, such as a liquid.

9. The vibration damping toolholder as claimed in claim 8, wherein the damping fluid is selected and distributed in the internal cavity such that a target natural frequency of the vibration damping tool holder is decreased thereby at most 15%.

10. The vibration damping toolholder as claimed in claim 1, further comprising an auxiliary elastic element arranged in the cavity, wherein the auxiliary elastic element is arranged and configured to be excited by the tuning mass only when the tuning mass pivots above a threshold angle.

11. The vibration damping toolholder as claimed in claim 8, wherein the auxiliary elastic element comprises a polymer.

12. The vibration damping toolholder as claimed in claim 9, wherein the auxiliary elastic element is an O-ring arranged on a periphery of the tuning mass or the primary spring element.

13. The vibration damping toolholder as claimed in claim 10, wherein the tuning mass is maximally pivotable a maximal angle, and wherein the threshold angle is at least 20% of the maximal angle.

14. The vibration damping toolholder as claimed in claim 1, wherein the first holder body end is a front end for supporting a cutting head.

15. A boring tool comprising the vibration damping toolholder as claimed in claim 1.

16. The boring tool as claimed in claim 15, further comprising a cutting head, wherein the cutting head is connected to the holder body at the first holder body end.
